(19) United States
(12) Patent Application Publication
(10) Pub. No.: US 2019/0275659 A1
(43) Pub. Date: Sep. 12, 2019

(54) Telescopic Pole For Swimming Pool Tools

(71) Applicant: James R. Conrad, Salinas, CA (US)

(72) Inventor: James R. Conrad, Salinas, CA (US)

(21) Appl. No.: 15/932,534

(22) Filed: Mar. 12, 2018

(51) Int. Cl. B25G 1/04; E04H 4/16; F16B 7/10

(52) U.S. Cl. CPC B25G 1/04; F16B 7/105; E04H 4/1609

(57) ABSTRACT

An apparatus for cleaning swimming pools, cement finishing tools, and wire ceiling applications, having an outer tube having a collar and angled detent, and a mechanism for attaching a tool. A dodecagon shaped inner tube configured to be received within the outer tube within an aperture in the collar. The inner tube is shaped to slide within the outer tube to a selected position in relation to the outer tube, allowing for the angled detent to position and secure the inner tube within the outer tube. A plurality of apertures are aligned on the inner tube, so that the angled detent, which includes a locking mechanism, which may be a tapered or ringed pin that is operably engaged with one of the apertures, to secure the inner tube at a selected position within the outer tube.

### BACKGROUND OF THE INVENTION

### Technical Field

This invention relates to devices for cleaning swimming pools, cement finishing tools, ceiling wire tools and the like, and more particularly to an apparatus and method using a telescopic or expandable pole for attachment to tools for cleaning swimming pools, cement finishing tools, ceiling wire apparatus, and other objects.

### Background Art

Various devices have been proposed and implemented for holding and positioning tools and other articles using telescopic poles, sometimes referred to as telepoles. Such devices allow a user to both grip the tool and increase extension, reach, and leverage. Many examples of such prior extendable handles for tools and other implements exist and include, extendable handles for shovels, brushes, hammers, screwdrivers, mops, rakes, and the like. Although prior devices have been adapted and used for such various purposes, there exists a need for a telescopic handle for swimming pool cleaning devices which can be used for positioning and securing a cleaning tool securely even under high pressure and tension which arises from strongly pushing or pulling the tool through water.

A telescoping or extendable handle are very useful for swimming pool cleaning tools so that the user can clean the pool without getting wet while standing or walking along the side of the pool. Similar extendable handle tools are used for painting, window washing, and concrete and paving operations.

Examples of extendable handles or telescoping poles are those with two separate lengths of tubing, configured so that one slides within the other to adjust the overall length of the pole, and a positioning or locking device so that when locked, the two lengths do not move or slide with respect to one another.

Such extendable handle or telescoping poles are typically composed of aluminum, fiberglass or other strong, durable material. A plurality of apertures are positioned so that a pin or other fastening means can be inserted often via a collar type mechanism and thereby position the tubes at varying lengths in relation to each other as desired.

Other telescoping poles use external locking devices, compression rings, or sliding lock assemblies for retaining and positioning the tubes relative to one another. Other examples include internal and external locking devices, multiple locking mechanisms and the use of three tubes.

Such prior telescoping or extendable poles, however, have serious limitations which have limited there usefulness, especially in the application to swimming pool tools and cleaning devices. One such limitation is that the locking mechanisms often weaken or loosen, resulting in collapse or slippage when pressure is applied during use.

Further such prior poles are prone to bending and weakening of the locking means which are subject to wear and tear over time. This results in deformation and sliding of the inner tube within the outer tube. And may result in jamming or the inability of the inner tube to properly slide and be aligned within the outer tube. Or if the locking and position means fail the inner tube may be overextended and completely separate from the inner tube. Prior poles typically used a series of bolt holes drilled into the inside pole which met with a pin located in a handle assembly that is controlled by spring pressure which forces the pin into a hole and stays in place while forward and backward movement is applied. The major problem with this prior mechanism was that the pivot hole or bolt hole located in the handle has to be above the location of the drilled holes in the inside tube. By locating this pin hole above the tube, this creates an alignment which favors the pin to pull up an out of the hole, resulting in pole failure and collapse.

Further limitations of prior devices are seen with grips that fail to secure tightly to the inner tube allowing slippage of the inner tube if that tube slides too far within the outer tube. This may require repositioning or reassembly of the pole again prior to use.

The present invention provides an improved telescoping or extendable pole for swimming pool cleaning and maintenance tools, cement finishing tools, ceiling wire applications, and the like, which overcomes the defects of prior telescoping or extendable poles and handles. The present invention provides a reliable, stable, and easy to use and operate telescoping pole or handle for swimming pool cleaning and maintenance tool, and other tools using extendable handles. The improved telescoping or extendable pole of the present invention comprises an inner dodecagon shaped tube which slides within an outer tube and an angled locking detent means to secure the inner tube in a desired position within the outer tube. In one embodiment the inner and outer tubes are fabricated from a durable, lightweight material such as aluminum, but may be otherwise. If desired a reinforcement wall may be provided, but may be otherwise. One end of the inner tube preferably has a detachable grip mounted thereon, allowing for easy gripping and grasping of the inner tube. The inner dodecagon shaped tube has a plurality of apertures along its length which are positioned to receive a pin element or other fastening means of the detent means. The pin element is preferably tapered or having a ring groove or notch therein. On the end of the outer tube, a housing or collar is provided through which the inner tube slides and in which the angled detent means are preferably housed. The detent means, which may be a pin or other fastening device is preferably attached to an angled arm element and secured by a screw, pin, bolt, or other fastening means to the collar or housing. An actuator button is pressed to depress the pin or other detent means into a selected aperture in the inner tube, thereby adjusting the length of the telescoping pole or handle as desired. Preferably, the end of the outer tube opposite from the housing or collar, has a plurality of apertures for attaching and detaching swimming pool cleaning tool and additional apertures may be provided for draining water from the outer tube further if a swimming pool cleaning tool is secured to the outer tube.

Another object of the present invention, is to provide a telescoping or extendable tools for cleaning swimming pools and the like, in which an angled detent mechanism securely maintains the integrity of the extended length of the pole under all conditions of use.

A still further object of the present invention is to provide a lightweight telescoping pole for pool cleaning tools and the like, that includes a spring or compression type device for locking the detent in a desired location, thereby firmly securing the inner and outer tubes at a desired length.

Yet another object of the present invention is to provide a lightweight telescoping pole for pool cleaning tools and the like, that includes a grooved grip that is detachably secured to the inner tube at an end thereof.

Accordingly, the primary object of the present invention is to provide a telescoping or expandable pole or handle for swimming pool cleaning tools, that is very stable and secure under high pressure and stress, and is easy to assemble or disassemble, and may be used with a wide variety of pool cleaning tools, and other tools as desired.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out in the appended claims.

### SUMMARY OF THE INVENTION

To achieve the foregoing objects, and in accordance with the purpose of the invention as embodied and broadly described herein, an apparatus for cleaning swimming pools, cement finishing tools, ceiling wire applications and the like, comprises an outer tube having a first end and a second end. The first end of the outer tube has a collar and angled detent. The second end of the outer tube has a mechanism, such as apertures, for attaching a tool. A dodecagon shaped inner tube has a first end and a second end, and includes a detachable grooved grip for grasping and positioning the apparatus. The second end of the inner tube is adapted and configured to be received within the outer tube within an aperture in said collar. The inner tube is shaped to slide within the outer tube to a selected position in relation to said outer tube, allowing for the angled detent to position and secure the inner tube within the outer tube. A plurality of apertures are aligned on the inner tube, so that the angled detent, which includes a locking mechanism, which may be a pin, which may be tapered or ringed to snap in the aperture. The pin is snapped into or operably engaged with one of the apertures, to secure and position the inner tube at a selected position within the outer tube. In one embodiment the locking mechanism of the angled detent is a pin that is tapered has a ringed notch therein, and the angled detent includes an angled actuator arm. The locking mechanism of the angled detent includes an actuator means, which may comprise a enlarged surface area to facilitate activating the angled actuator arm secured to a spring mechanism. The collar includes a fastening mechanism, such as a screw or bolt, for securing and tightening the collar to the outer tube. The inner tube may include an inner insert for engagement with the angled detent. The angled detent may includes a ring-shaped mechanism for securing the locking mechanism of the angled detent within one of said plurality of apertures in the inner tube.

### BRIEF DESCRIPTION OF DRAWINGS

The accompanying drawings, which are incorporated in and constitute a part of the specification, illustrate a preferred embodiment of the invention and, together with a general description given above and the detailed description of the preferred embodiment given below, serve to explain the principles of the invention.

FIG. 1 shows a telescopic pole for swimming pool tools and the like, having a pool cleaning tool operably attached thereto, according to the invention.

FIG. 2 shows a stop ring mechanism for the telescopic pole for swimming pool tools and the like, according to the invention.

FIG. 3, shows the inner structure of the dodecagon shaped tube, according to the invention.

FIG. 4 shows a collar housing and angled detent configured according to the invention.

FIG. 5 shows a top view of the angled detent within the housing, according to the invention.

FIG. 6, shows a side view of the housing for the angled detent with attachment screw or bolt, according to the invention.

FIG. 7 shows an end view of the housing for the angled detent having a dodecagon shaped inner surface, according to the invention.

FIG. 8 shows a shows a top perspective view of the housing for the angled detent having a dodecagon shaped inner surface, according to the invention.

FIG. 9 shows the angled detent removed from the housing, according to the embodiment of the invention.

FIG. 10 shows a side view of the angled detent removed from the housing and having a tapered pin, according to one embodiment of the invention.

FIG. 11 shows a tapered pin according to one embodiment of the invention.

FIG. 12 shows a bottom view of the angled detent removed from the housing, according to one embodiment of the invention.

FIG. 13 shows a pin attachment mechanism of the angled detent with pin, according to one embodiment of the invention.

FIG. 14 shows a ringed or notched pin according to one embodiment of the invention.

FIG. 15 shows a bottom view of the angled detent removed from the housing, according to one embodiment of the invention.

FIG. 16 shows a disassembled spring pressure mechanism of the angled detent, according to one embodiment of the invention.

FIG. 17 shows the assembled spring pressure mechanism of of the angled detent, according to one embodiment of the invention.

### DETAILED DESCRIPTION OF THE PREFERRED EMBODIMENT

Reference will now be made in detail to the present preferred embodiments of the invention as illustrated in the accompanying drawings.

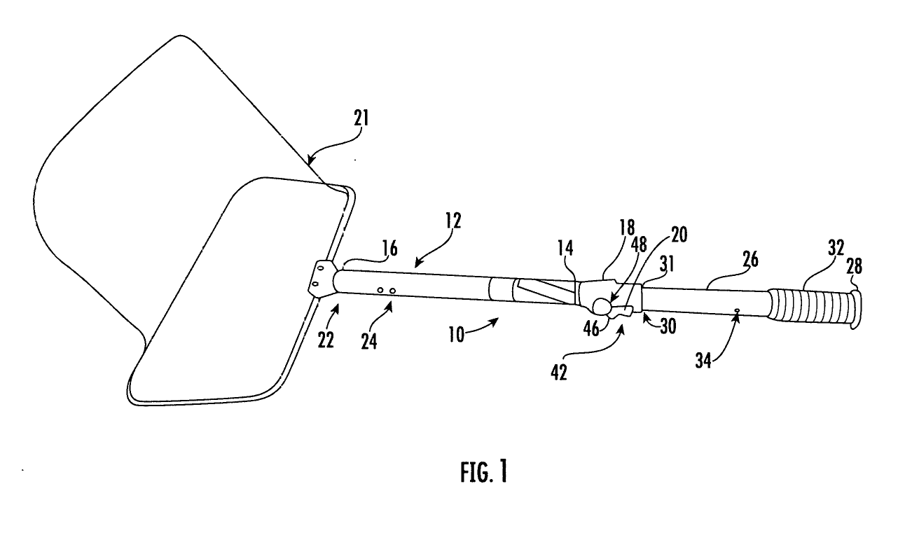

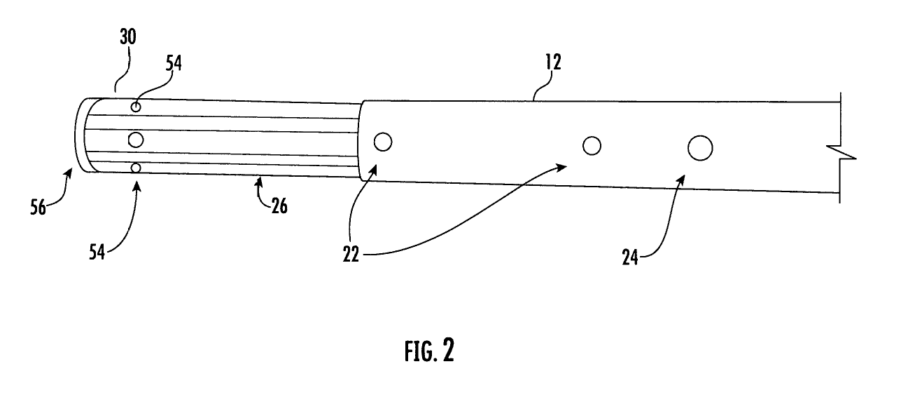

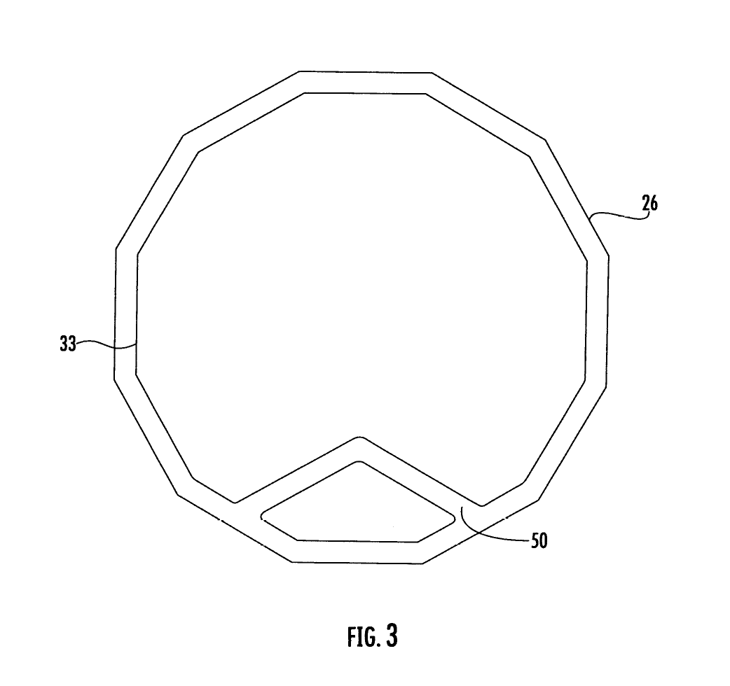

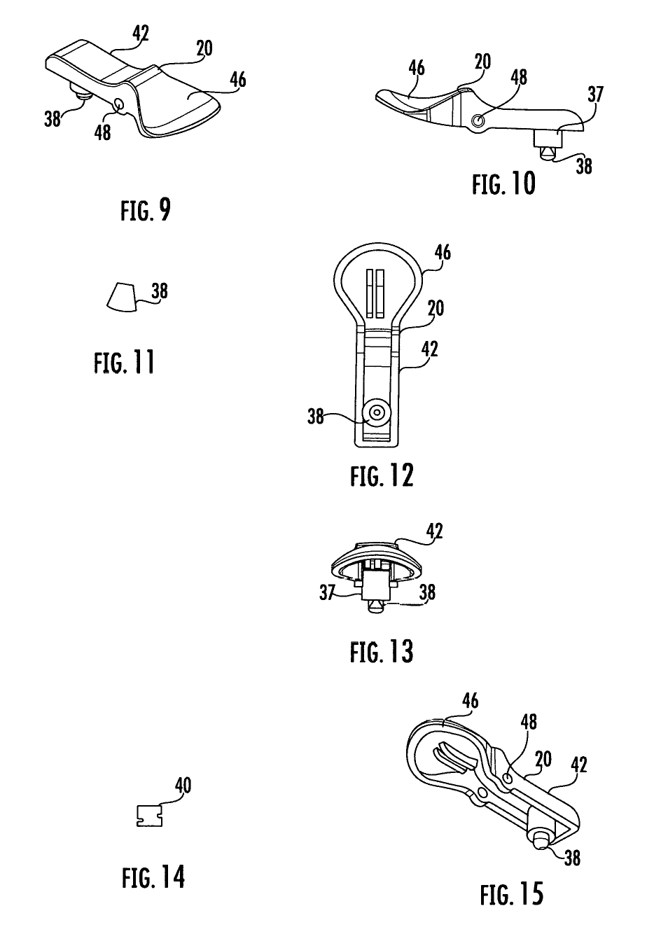

In accordance with the present invention, and as seen in FIG. 1, there is provided in a preferred embodiment of the invention, an apparatus or tool 10, for cleaning swimming pools, cement finishing tools, ceiling wire applications and the like, comprising an outer tube 12, having a first end 14, and a second end 16. The first end 14, of the outer tube 12, has a collar housing 18, and angled detent 20, providing a lock assembly, and the second end 16, of said outer tube 12, having means for attaching a tool thereto, such as leaf skimmer 21, which may be a plurality of apertures 22, and drain hole 24. A dodecagon shaped inner tube 26, is provided having a first end 28, and a second end 30, and includes a detachable grooved grip 32, for grasping and positioning apparatus 10, as desired. The second end 30, of the inner tube 26, is adapted and configured to be received within the outer tube 12, within an aperture 31, of collar housing 18. The inner tube 26, is shaped to slide within the outer tube 12, to a selected position in relation to the outer tube 12, allowing for the angled detent 20, to position and secure the inner tube 26, within the outer tube. A plurality of apertures 34, are aligned on the dodecagon shaped inner tube 26, so that the angled detent 20, which includes a locking mechanism, may be operably engaged with one of the apertures 34, so as to secure and position the inner tube 26, at a selected position within the outer tube 12. The apparatus, in a preferred embodiment uses a tapered 38, or ringed pin 40, best seen in FIGS. 10, 11, and 14, for the locking means of the angled detent 20. The locking means of the angled detent 20, also preferably includes an angled actuator arm 42, see for example FIG. 4. The locking means of the angled detent 20, also includes an actuator means, comprising a enlarged surface area 46, to facilitate activating angled actuator arm 42, when pushed or depressed. The collar housing 18, which houses angled detent 20, or lock assembly, includes a fastening means 48, such as a screw, bolt or the like, for securing and tightening collar housing 18, to outer tube 12. Preferably, the inner dodecagon shaped tube 26, includes an inner insert 50, best seen in FIG. 3, for support and for engagement with the detent pin.

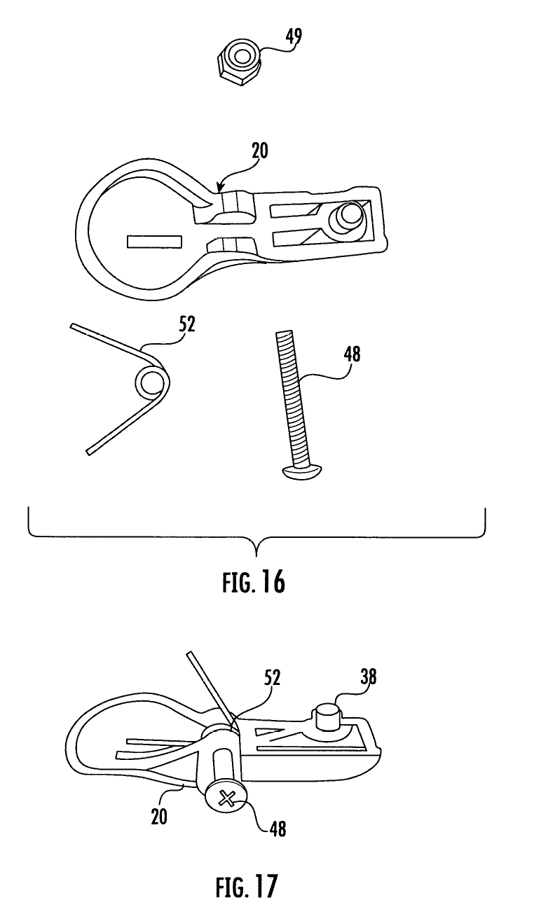

As seen in FIG. 1, a preferred embodiment of the apparatus for cleaning swimming pools, cement finishing tools, ceiling wire applications 10, is shown. Preferably, the telescoping pole comprised of outer tube 12, and inner dodecagon shaped tube 26, utilize the angled detent 20, with either tapered ring 38, or notched or ringed pin 40, for locking the apparatus in position. It is essential that the pole can be locked in a chosen position without collapsing or rotating. The locking mechanism provided by angled detent 20, positioning and snapping or locking and pins 38, or 40, in apertures 34, is preferably controlled by a spring pressure mechanism, comprising a spring 52, best seen in FIGS. 16 and 17, operably positioned within angled detent 20. The spring pressure forces pin 38 or 40, into one of the apertures 34, in inner dodecagon shaped tube 26, and because of the angled detent 20, and tapered 38, or ringed pin 40, the pole is locked together at a desired length and remains stable when either forward or backward motion is applied. The tapered ring 38, or angled ring 40, prevent the pins from pulling up and out of apertures 34.

It is also seen in FIG. 1, that collar housing 18, prevents the pins from exposure to outside damage if the apparatus 10, is dropped on the ground. The locking mechanism provided by angled detent 20, and the tapered pin 38, or ringed pin 40, with spring 52, is completely protected by collar housing 18, which protects the pin and detent mechanism form outside damage.

With reference now to FIG. 2, an embodiment of the apparatus or tool 10, is shown according to another embodiment of the invention where a plurality of stop buttons 54, are positioned near the second end 30, of inner dodecagon shaped tube 26. A stop ring 56, is operably secured to the end and this provides a stop on the pole, preventing inner tube 26, from pulling out of outside tube 12. Stop buttons 54, stop when hitting the inside of collar housing 18, which in addition to stop ring 56, creates a stop. In alternative embodiments, stop ring 56, may be eliminated, thereby using the stop buttons 54, as the sole stop mechanism.

In FIG. 3, shows the inner structure of the inner dodecagon shaped tube 26, according to a preferred embodiment of the invention. Inner tube 26, preferably has insert and elevated portion 50, for support and for engagement with the locking assembly of the angled detent, and dodecagon shaped inner wall 33.

With reference to FIG. 4 collar housing 18, and angled detent 20, are shown detached from the outer and inner tube, and configured according to a preferred embodiment of the invention. Preferably angled detent 20, is configured with actuator means, which is shown as enlarged surface area 46, and angled actuator arm 42, and dodecagon shaped inner wall 31.

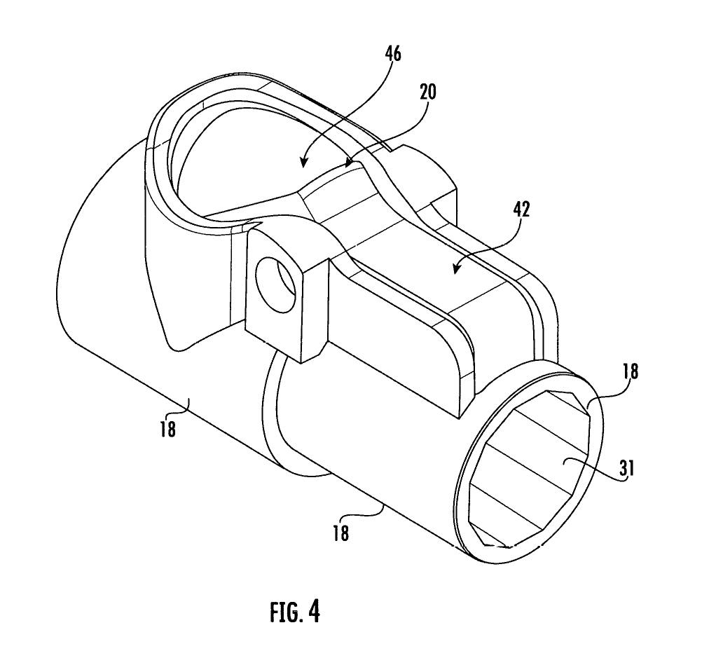

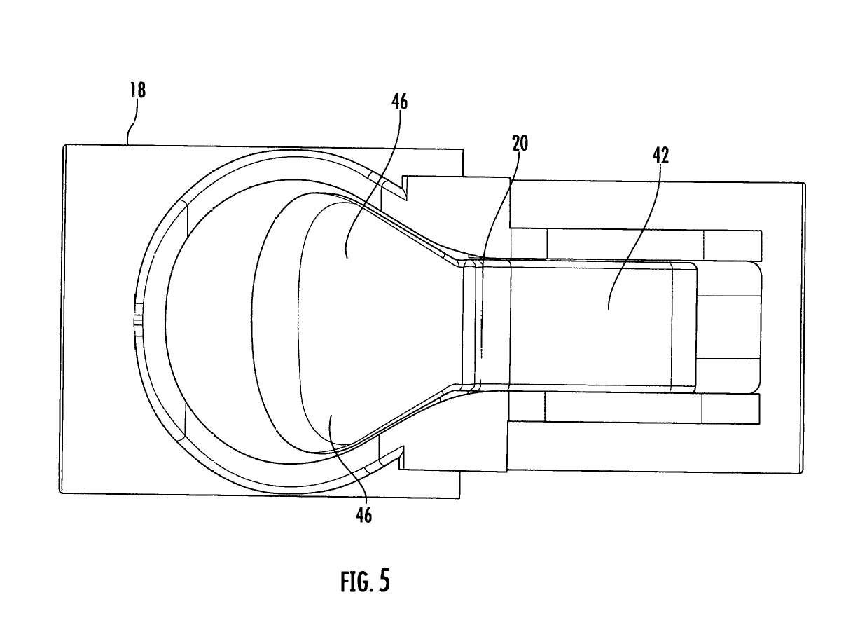

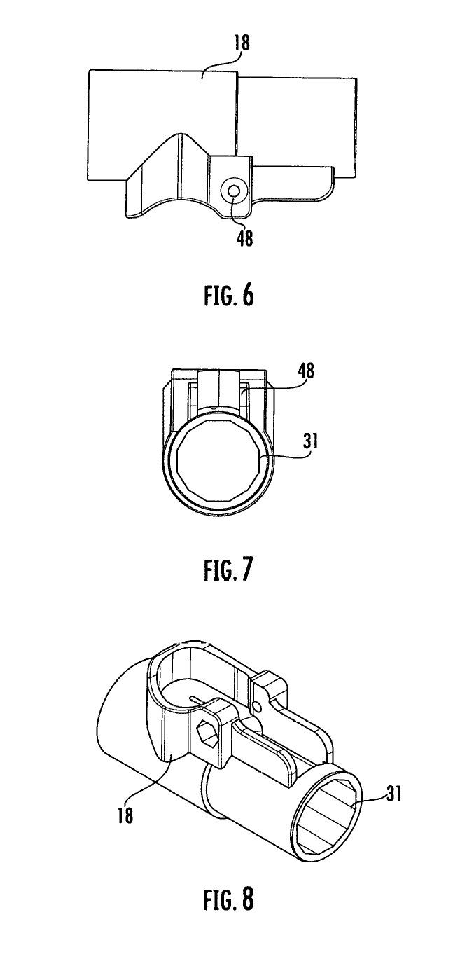

In FIG. 5a top view of the angled detent 20, within the housing 18 is shown, according a preferred embodiment of the invention. Preferably angled detent 20, is configured with actuator means, which is shown as enlarged surface area 46, and angled actuator arm 42. A side view of collar housing 18, for the angled detent with attachment screw or bolt 48, is seen in FIG. 6, according to the invention.

In FIG. 7 an end view of the collar housing 18, for the angled detent 20, is shown, having dodecagon shaped inner surface 31, to receive the inner tube of the telescoping pole, according to the invention.

With reference now to FIG. 8, shows a top perspective view of the collar housing 18, for the angled detent having a dodecagon shaped inner surface. In FIG. 8, the collar housing 18, is illustrated alone, without angled detent 20 or the inner and outer tubes, for illustrative purposes, according to a preferred embodiment of the invention.

In FIG. 9, angled actuator arm 42, of angled detent 20, is removed from the collar housing 18. Fastening means 48, which can be a screw, bolt, rivet, or other fastening mechanism well know in the art is shown. A preferred configuration of enlarged surface area 46, and angled actuator arm 42 is shown. Tapered pin 38, is shown providing a locking means for the telescoping pole are shown according to a preferred embodiment of the invention.

Referring now to FIG. 10, a side view of the angled detent 20, removed from the housing 18, and having tapered pin 38, secured to mount 37, is shown, according to one embodiment of the invention. In FIG. 11, tapered pin 38, is shown detached from the angled detent. Tapered pin 38, may be provided in alternative configurations such as seen in FIGS. 13 and 14, where a notch or ring is provided, so that the pin is ringed. In any configuration, whether tapered, or ringed, or notched, the pin is controlled by spring pressure and is snapped or pushed into one of the plurality of apertures on the dodecagon shaped inner tube.

Preferably, outer tube 12, and dodecagon inner tube 26, are composed of a durable resilient material such a aluminum or other metal, plastic, rubber, or the like. It is also noted, that in other embodiments, inner tube 26, may have an alternative configuration which is not dodecagon shaped, such as round, or rectangular, hexagon, or pentagon shaped as desired, but preferably is shaped a as dodecagon. Outer tube 12, and inner tube 26 may be of any selected length depending upon the application and use. For example, inner tube may be 3 feet long, 5 feet long, 8 feet long, or otherwise as desired. Collar housing 18, is preferably composed of a durable resilient material such as plastic, rubber, composite, metal, or the like. In the preferred embodiment of the invention, tapered pin 38, or ringed or notched pin 40, are composed of a durable resilient material such as plastic, metal, composite, or thermoplastic, for example. The detachable grooved grip 32, may be composed of plastic, rubber, neoprene, or other flexible, durable, material.

With reference now to FIG. 12a bottom view of the angled detent 20, is shown removed from the housing, according to one embodiment of the invention. Angled detent 20, is configured with enlarged surface area 46, and angled actuator arm 42, is shown from a bottom view. Tapered pin 38, which may of course be replaced with a ringed or notched pin, is also shown.

FIG. 13 shows a pin attachment mechanism of the angled detent with pin 38, secured to mount 37, and to angled actuator arm 42, according to one embodiment of the invention. Tapered pin 38, may be replaced by ringed or notched pin 40, best seen in FIG. 14.

FIG. 15 shows a bottom view of the angled detent 20, with pin 38, removed from the housing, enlarged surface area 46, for facilitating pressing and snapping pin 38, in place in aperture 34 of inner dodecagon shaped tube 26, according to a preferred embodiment of the invention embodiment of the invention.

A disassembled spring pressure mechanism is shown FIG. 16, with spring 52, screw 48, bolt 49 to secure screw 48, and angled detent 20, according to one embodiment of the invention.

Referring now to FIG. 17 the assembled spring pressure mechanism of the angled detent, is shown assembled by detached from housing collar 18, according to a preferred embodiment of the invention. Preferably spring 52, is operably engaged to screw 48, as shown, providing a spring pressure mechanism to force tapered pin 38, or notched or ringed pin 40, into an aperture 34, of inner dodecagon shaped tube 26.

In operation and use, the telescoping pole 10, of the present invention provides an apparatus that may be used for cleaning swimming pools, cement finishing tools, ceiling wire tools and the like. In particular, the telescoping pole 10, provides an apparatus for attachment to tools for cleaning swimming pools, cement finishing tools, ceiling wire tools, or the like. Telescoping pole or apparatus 10, may be easy, safely, and efficiently used to extend the reach of the user while using the tool. Telescoping pole 10, easily and quickly snaps or locks into place by using a series of apertures in an inner dodecagon shaped pole. A pin that is tapered, notched or ringed and is used and controlled by spring pressure that forces the pin into an aperture and stays in place while forward and backward movement is applied. By providing a tapered or ringed pin, this eliminates the pin pulling up and out of the aperture when pressure and force is applied. This also creates a stopping effect on the pulling up of the pin from the aperture, resulting in a stable and reliable lock position. Telescoping pole or apparatus 10, may be used for pool cleaning, cement finishing, ceiling wire applications and any application that requires different lengths of pole or tubing at different times of application. Telescoping pole 10, may be provided in a wide variety of different sizes and configurations.

Additional advantages and modification will readily occur to those skilled in the art. The invention in its broader aspects is, therefore, not limited to the specific details, representative apparatus and illustrative examples shown and described. Accordingly, departures from such details may be made without departing from the spirit or scope of the applicant's general inventive concept.

What is claimed is:

1. An apparatus for cleaning swimming pools, cement finishing tools, ceiling wire applications, and the like, comprising:
an outer tube having a first end and a second end, said first end of the outer tube having a collar housing and angled detent, said second end of said outer tube having means for attaching a tool;
a dodecagon shaped inner tube having a first end and a second end, and includes a detachable grooved grip for grasping and positioning the apparatus; said second end of said inner tube is adapted and configured to be received within said outer tube within an aperture in said collar housing; the inner tube is shaped to slide within said outer tube to a selected position in relation to said outer tube, allowing for said angled detent to position and secure the inner tube within the outer tube; and
a plurality of apertures aligned on the inner tube, so that the angled detent, which includes a locking means, may be operably engaged with one of said apertures, to secure and position the inner tube at a selected position within said outer tube.

2. The apparatus of claim 1, wherein said locking means of said angled detent is a tapered pin.

3. The apparatus of claim 1, wherein said locking means of said angled detent is a ringed pin.

4. The apparatus of claim 1, wherein said locking means of said angled detent includes an angled actuator arm.

5. The apparatus of claim 1, wherein said locking means of said angled detent includes an actuator means, comprising a enlarged surface area to facilitate activating said angled actuator arm.

6. The apparatus of claim 1, wherein said collar housing includes fastening means for securing and tightening said collar housing to said outer tube.

7. The apparatus of claim 1, wherein said inner tube includes an inner insert for engagement with said angled detent.

8. The apparatus of claim 1, wherein said angled detent includes a ring-shaped mechanism for securing said locking means of said angled detent within one of said plurality of apertures in the inner tube.

9. A telescoping pole for swimming pool cleaning tools, comprising:
an outer tube having a first end and a second end, said first end of the outer tube having a collar and angled detent secured thereto, said second end of said outer tube having means for attaching a tool;
a dodecagon shaped inner tube having a first end and a second end, and includes a detachable grip for grasping and positioning the apparatus; said second end of said inner tube is adapted and configured to be received within said outer tube within an aperture in said collar; the inner tube is shaped to slide within said outer tube to a selected position in relation to said outer tube, allowing for said angled detent to position and secure the inner tube within the outer tube; and
a plurality of apertures aligned on the inner tube, so that the angled detent, which includes a locking means, may be operably engaged with one of said apertures, to secure and position the inner tube at a selected position within said outer tube.

10. The telescoping pole for swimming pool cleaning tools of claim 9, wherein said locking means of said angled detent is a tapered pin.

11. The telescoping pole for swimming pool cleaning tools of claim 9, wherein said locking means of said angled detent is a ringed pin.

12. The telescoping pole for swimming pool cleaning tools of claim 9, wherein said locking means of said angled detent includes an angled actuator arm.

13. The telescoping tool for swimming pool cleaning tools of claim 9, wherein said locking means of said angled detent includes an actuator means, comprising a enlarged surface area to facilitate activating said angled actuator arm.

14. The telescoping pole for swimming pool cleaning tools of claim 9, wherein said collar includes fastening means for securing and tightening said collar to said outer tube.

15. The telescoping pole for swimming pool cleaning tools of claim 9, wherein said inner tube includes an inner insert for engagement with said angled detent.

16. A telescoping tool for swimming pool cleaning tools, comprising:
an outer tube having a first end and a second end, said first end of the outer tube having a collar housing an angled detent, said second end of said outer tube having means for attaching a tool;
a dodecagon shaped inner tube having a first end and a second end, and includes a detachable grooved grip for grasping and positioning the apparatus; said second end of said inner tube is adapted and configured to be received within said outer tube within an aperture in said collar; the inner tube is shaped to slide within said outer tube to a selected position in relation to said outer tube, allowing for said angled detent to position and secure the inner tube within the outer tube; and
a plurality of apertures aligned on the inner tube, so that the angled detent, which includes a locking mechanism, may be operably engaged with one of said apertures, to secure and position the inner tube at a selected position within said outer tube, thereby allowing for the length of the telescoping handle to be adjusted to a desired length.

17. The telescoping tool for swimming pool cleaning tools of claim 16, wherein said locking mechanism of said angled detent includes a tapered pin.

17. The telescoping tool for swimming pool cleaning tools of claim 16, wherein said locking mechanism of said angled detent includes a ringed pin.

18. The telescoping tool for swimming pool cleaning tools of claim 16, wherein said locking mechanism of said angled detent includes an angled actuator arm.

19. The telescoping handle for swimming pool cleaning tools of claim 16, wherein said locking mechanism of said angled detent includes an actuator means, comprising a enlarged surface area to facilitate activating said angled actuator arm.
